(19) United States
(12) Patent Application Publication
(10) Pub. No.: US 2005/0028215 A1
(43) Pub. Date: Feb. 3, 2005

(54) Network camera supporting multiple IP addresses

(76) Inventor: Yavuz Ahiska, Surrey (GB)

Correspondence Address: SAWYER LAW GROUP LLP, P.O. Box 51418, Palo Alto, CA, 94303, US

(21) Appl. No.: 10/861,021

(22) Filed: Jun. 3, 2004

Related U.S. Application Data
(60) Provisional application No. 60/475,327, filed on Jun. 3, 2003.

(51) Int. Cl. H04N 7/173; H04N 7/16; H04L 12/28; H04L 12/56

(52) U.S. Cl. 725/105; 725/143; 348/211.99; 348/211.1; 370/395.52

(57) ABSTRACT

The invention provides a video camera capable of transmitting and receiving more than one Internet Protocol address. The video camera comprises an optical and imaging system capable of capturing a wide field of view from which a plurality of views may be extracted. An image processing circuit is coupled to said optical and imaging system and is capable of converting said plurality of views into a plurality of packets suitable for transmission over a network. A transmitting circuit is coupled to said processing circuit and is capable of transmitting said plurality of packets with a different transmitting Internet Protocol address for each view. A receiving circuit is capable of receiving packets with Internet Protocol addresses corresponding to said transmitting Internet Protocol addresses, said packets containing control information and the address indicating a view that the control information pertains to, said control information containing camera control commands.

### CROSS-REFERENCE TO RELATED APPLICATIONS

The present invention is related to the following copending U.S. patent applications:

U.S. patent application Ser. No. ______ (Attorney Docket No. 2823P), entitled “Correction of Optical Distortion by Image Processing”, filed on even date herewith and assigned to the assignee of the present invention.

U.S. patent application Ser. No. ______ (Attorney Docket No. 2838P), entitled “Multiple View Processing in Wide-Angle Video Camera”, filed on even date herewith and assigned to the assignee of the present invention.

U.S. patent application Ser. No. ______ (Attorney Docket No. 2839P) entitled “Multiple Object Processing in Wide-Angle Video Camera”, filed on even date herewith and assigned to the assignee of the present invention.

### FIELD OF THE INVENTION

The invention relates generally to video cameras and specifically to the division of views or images from a video camera to different sites for the purpose of surveillance or inspection.

### BACKGROUND OF THE INVENTION

Surveillance and monitoring systems typically dedicate a camera to each field of view, with appropriate monitors and recording equipment for each camera.

Internet Protocol (IP) video cameras are becoming wide spread in surveillance and inspection but are limited to providing a single network address for each camera. Internet Protocol [ISI81] operates within the network layer of the International Standard Organization's Open System Interconnect model [ISO94]. In this system, packets of data transmitted through a network are marked with addresses that indicate their destination. Established routing algorithms determine an appropriate path through the network such that the packet arrives at the correct device. Packets also contain information that indicates the address of the sending device such that the receiving device may reply to the transmitter.

In a networked surveillance or inspection system, one or more base stations are connected to cameras by a network, for example in FIG. 1. Network IP camera 10 is identified by a unique network address, as is each base station 20 and 30. Base stations 20 and 30 may send commands to camera 10 by transmitting packets marked with their address. Camera 10 sends information including video data to a specific base station by transmitting packets marked with the base station's address. A base station may broadcast packets to more than one camera by using broadcast aspects of the Internet Protocol, and a camera may broadcast data to more than one base station by similar means. Camera 10 captures image 40 and transmits it to base stations 20 and 30, which each display the entire image captured by camera 10.

One problem with this is the expense and redundancy of the equipment. What is needed is a system for reducing the amount of equipment, simplifying and expanding the versatility of security systems.

### SUMMARY OF THE INVENTION

The invention provides a video camera capable of transmitting and receiving more than one Internet Protocol address. The video camera comprises an optical and imaging system capable of capturing a wide field of view from which a plurality of views may be extracted. An image processing circuit is coupled to the optical and imaging system and is capable of converting said plurality of views into a plurality of packets suitable for transmission over a network. A transmitting circuit is coupled to the processing circuit and is capable of transmitting said plurality of packets with a different transmitting Internet Protocol address for each view. A receiving circuit is capable of receiving packets with Internet Protocol addresses corresponding to said transmitting Internet Protocol addresses, said packets containing control information and the address indicating a view that the control information pertains to, said control information containing camera control commands.

### BRIEF DESCRIPTION OF THE DRAWING(S)

FIG. 1 is a prior art diagram illustrating a video camera and network base station system.

FIG. 2 is a block diagram illustrating one embodiment of the invention.

FIG. 3 is a block diagram illustrating one embodiment of the video camera from FIG. 2.

FIG. 4 is a flow diagram illustrating one method of transmitting a plurality of views from a video camera.

FIG. 5 is a flow diagram illustrating one method of transmitting a plurality of views over a network from a video camera.

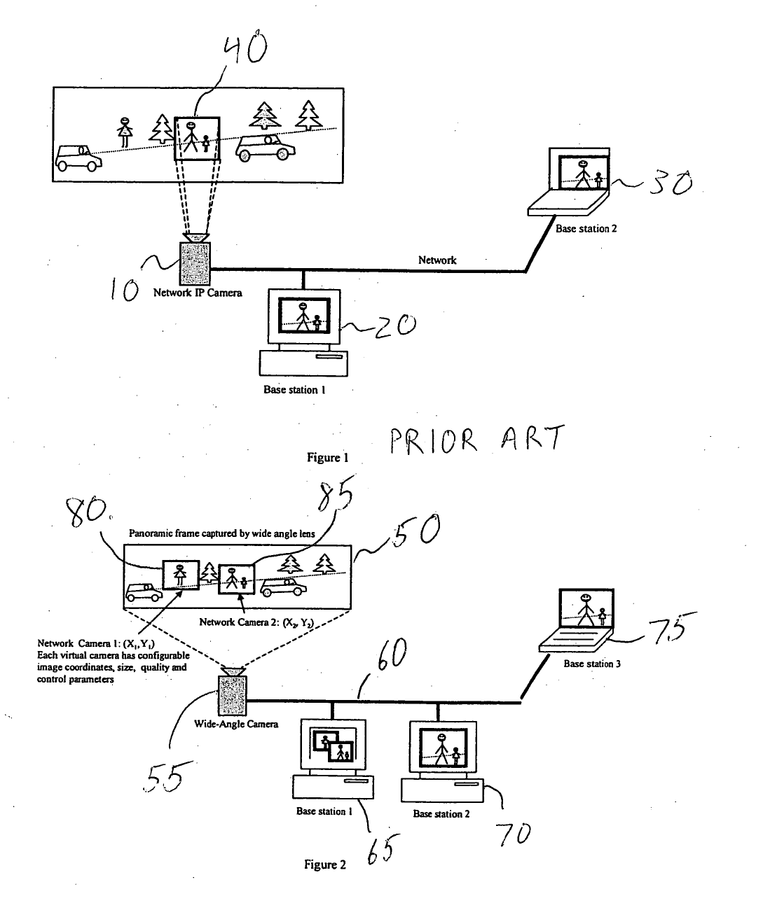

### DETAILED DESCRIPTION OF THE INVENTION

The invention relates generally to video cameras and specifically to the division of views or images from a video camera to different sites for the purpose of surveillance or inspection. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The invention relates to the design of a video camera that connects to a network for the purpose of remote surveillance or inspection and discloses how the appropriate use of network protocols may be used to give one camera the appearance of many. This effect is useful where cameras are capable of simultaneously capturing more than one view, for example as disclosed in co-pending patent application “Multiple View Processing in a Wide-Angle Video Camera,” attorney docket number 2839P, Application No. ______, and incorporated by reference herein.

FIG. 2 illustrates one embodiment of the invention where the use of multiple Internet Protocol (IP) addresses by a single camera appears to originate from more than one camera. Several views of the scene 50 captured by video camera 55 are transmitted across network 60 to receiving base stations 65, 70 and 75. Video camera 55 is a camera that is capable of capturing more than one channel of video and audio data, including for example a video camera with a wide-angle lens. View 80 has a separate IP address from view 85 and as such is indistinguishable from the data that would be presented by a number of separate cameras. As many systems used for video surveillance or remote inspection include the capability to receive data from multiple IP video cameras, the invention allows existing systems to make use of new multiple view cameras.

View 80, with coordinates (X₁,Y₁), is transmitted to, for example, base station 65. View 85, with coordinates (X₂,Y₂), is transmitted to base stations 65, 70 and 75. Views 80 and 85 become virtual cameras with configureable image coordinates, size, quality and control parameters.

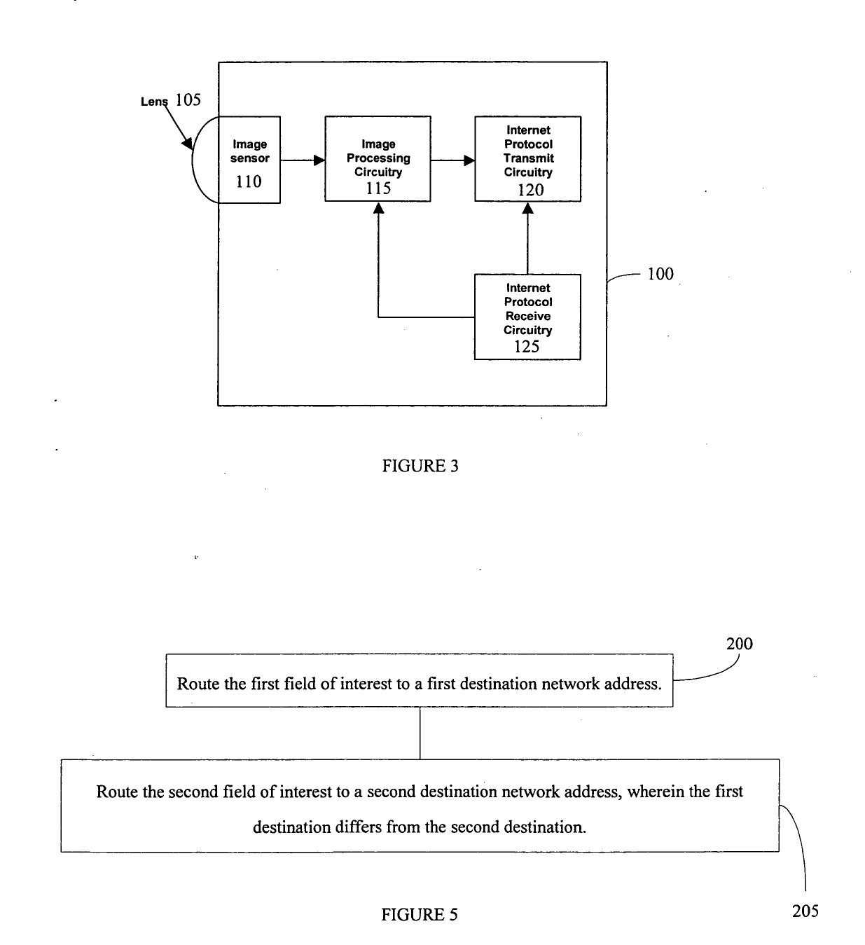

FIG. 3 illustrates one embodiment of the invention. Video camera 100 includes optical and imaging system 105, for example a wide-angle lens, conveying an image-to-image sensor 110. Image processing circuit 115 converts the video and audio data into packets suitable for transmission over a network. Transmitting circuit 120 sends the packets over the network with a different transmitting IP address for each view. Receiving circuit 125 receives control information marked with Internet Protocol addresses that correspond to those used to transmit the video and audio packets. Control information typically contains camera control commands. The information received by receiving circuit 125 may include the coordinates of the region-of-interest within the wide-angle field of view, exposure and color compensation controls, sharpness, control over compression, instructions to execute motion detection, or other algorithms. It should be clear to those skilled in the art that each of these circuits may be combined one with another in different combinations to reduce the cost of a particular embodiment.

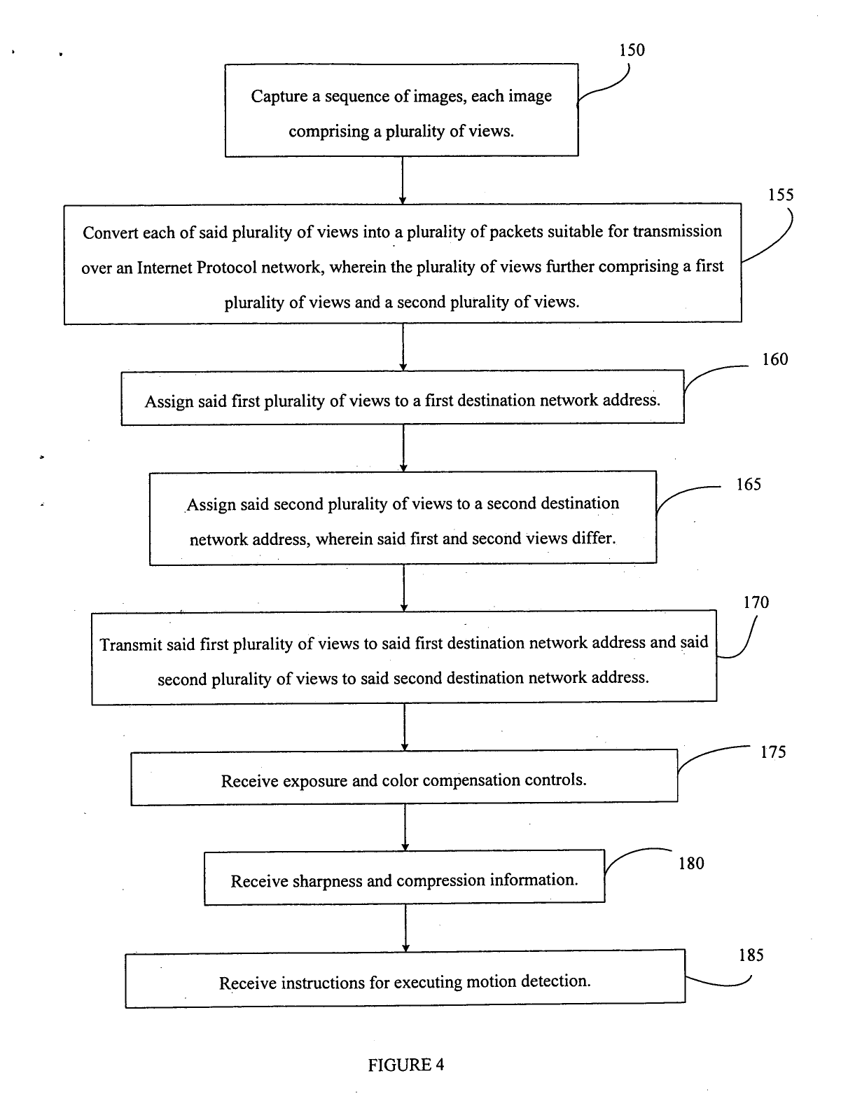

FIG. 4 is a flow chart illustrating a method of transmitting a plurality of views from a video camera. The video camera includes a lens, an image sensor coupled to the lens, and an image processing circuit coupled to the image sensor. In block 150, capture a sequence of images, each image comprising a plurality of views. In block 155, convert each of said plurality of views into a plurality of packets suitable for transmission over an Internet Protocol network, wherein the plurality of views further comprising a first plurality of views and a second plurality of views. In block 160, assign said first plurality of views to a first destination network address. In block 165, assign said second plurality of views to a second destination network address, wherein said first and second views differ. In block 170, transmit said first plurality of views to said first destination network address and said second plurality of views to said second destination network address. In block 175, receive exposure and color compensation controls. In block 180, receive sharpness and compression information. In block 185, receive instructions for executing motion detection.

FIG. 5 is a method of transmitting a plurality of views over a network from a video camera. The video camera includes a lens configured to receive an optical image, an image sensor coupled to the lens and configured to convert the optical image to an electronic image, and an image processing circuit coupled to the image sensor and configured to receive the electronic image and to assign a first field of interest to a first portion of the electronic image, and to assign a second field of interest to a second portion of the electronic image, wherein the first portion of the electronic image differs from the second portion of the electronic image. In block 200, route the first field of interest to a first destination network address. In block 205, route the second field of interest to a second destination network address, wherein the first destination differs from the second destination.

The foregoing has described methods for the implementation of a multiple view video camera that are given for illustration and not for limitation. Although the invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A video camera capable of transmitting and receiving more than one Internet Protocol address comprising:
an optical and imaging system capable of capturing a wide field of view from which a plurality of views may be extracted;
an image processing circuit coupled to said optical and imaging system and capable of converting said plurality of views into a plurality of packets suitable for transmission over a network;
a transmitting circuit coupled to said processing circuit and capable of transmitting said plurality of packets with a different transmitting Internet Protocol address for each view; and
a receiving circuit capable of receiving packets with Internet Protocol addresses, said packets containing control information and said address indicating a view that said control information pertains to, said control information containing camera control commands.

2. The video camera of claim 1 in which the plurality of views may be grouped together, each groups of views having a different transmitting Internet Protocol address.

3. The video camera of claim 1 in which the plurality of views may be grouped together, each groups of views having a different receiving Internet Protocol address.

4. The video camera of claim 1 in which data associated with a transmitting address includes audio data.

5. The video camera of claim 1 in which said transmitting circuit and said receiving circuit are combined in a single interface circuit.

6. The video camera of claim 1 in which said optical and imaging system and said image processing circuit are combined in a single circuit.

7. The video camera of claim 1 in which said control information includes commands specifically related to the execution of programmed algorithms by said image processing circuit.

8. The video camera of claim 7 wherein said first destination network address differs from said second destination network address.

9. The video camera of claim 6, said receiving circuit further configured to receive instructions for executing motion detection.

10. A method of transmitting a plurality of views from a wide-angle video camera comprising:
capturing a sequence of images, and extracting a plurality of views;
converting each of said plurality of views into a plurality of packets suitable for transmission over an Internet Protocol network;
transmitting said packets with a different transmitting Internet Protocol address for each view;
and assigning to each view a unique receiving Internet Protocol address for the purpose of receiving control information.

11. The method of claim 10 in which the plurality of views may be grouped together, each groups of views having a different transmitting Internet Protocol address.

12. The method of claim 10 in which the plurality of views may be grouped together, each groups of views having a different receiving Internet Protocol address.

13. The method of claim 10, said plurality of views further comprising a first plurality of views and a second plurality of views, the method further comprising:
assigning said first plurality of views to a first destination network address; and
assigning said second plurality of views to a second destination network address, wherein said first and second views differ.

14. The method of claim 13, further comprising:
transmitting said first plurality of views to said first destination network address and said second plurality of views to said second destination network address.

15. The method of claim 14 wherein said first destination network address differs from said second destination network address.

16. The method of claim 13, further comprising:
receiving exposure and color compensation controls.

17. The method of claim 13, further comprising:
receiving sharpness and compression information.

18. The method of claim 13, further comprising:
receiving instructions for executing motion detection.

19. A computer readable medium containing programming instructions for transmitting a plurality of views from a wide angle video camera and receiving control information, the programming instructions for:
capturing a sequence of images and extracting a plurality of views;
converting each of said plurality of views into a plurality of packets suitable for transmission over an Internet Protocol network; and
transmitting said packets with a different transmitting Internet Protocol address for each view;
and assigning to each view a unique receiving Internet Protocol address for the purpose of receiving control information.

20. The method of claim 19 in which the plurality of views may be grouped together, each groups of views having a different transmitting Internet Protocol address.

21. The method of claim 19 in which the plurality of views may be grouped together, each groups of views having a different receiving Internet Protocol address.

22. The computer readable medium of claim 19, said plurality of views further comprising a first plurality of views and a second plurality of views, said programming instructions further comprising:
assigning said first plurality of views to a first destination network address; and
assigning said second plurality of views to a second destination network address, wherein said first and second views differ.

23. The computer readable medium of claim 22, said programming instructions further comprising:
transmitting said first plurality of views to said first destination network address and said second plurality of views to said second destination network address.

24. The computer readable medium of claim 23 wherein said first destination network address differs from said second destination network address.

25. The computer readable medium of claim 22, said programming instructions further comprising:
receiving exposure and color compensation controls.

26. The computer readable medium of claim 22, said programming instructions further comprising:
receiving sharpness and compression information.

27. The computer readable medium of claim 22, said programming instructions further comprising:
receiving instructions for executing motion detection.
